(19) United States
(12) Patent Application Publication
(10) Pub. No.: US 2021/0218689 A1
(43) Pub. Date: Jul. 15, 2021

(54) DECENTRALIZED APPROACH TO AUTOMATIC RESOURCE ALLOCATION IN CLOUD COMPUTING ENVIRONMENT

(71) Applicant: SAP SE, Walldorf (DE)

(72) Inventors: Swati Verma, Delhi (IN); Nishil Bharill, Bangalore (IN); Ishan Shah, Ahmedab (IN)

(21) Appl. No.: 16/743,374

(22) Filed: Jan. 15, 2020

(51) Int. Cl. H04L 12/925; H04L 12/911; H04L 12/923; H04L 12/927

(52) U.S. Cl. CPC H04L 47/722; H04L 47/781; H04L 47/803; H04L 47/788; H04L 47/822; H04L 47/762

(57) ABSTRACT

According to some embodiments, a centralized resource provisioning system may associated with a plurality of end-user applications in a cloud-based computing environment. The centralized resource provisioning system may include a policy decision maker that generates a centralized recommendation for a computing resource of a first end-user application. An application decision maker may be associated with the first end-user application and generate a decentralized recommendation for the computing resource of the first end-user application. A machine controller of the centralized resource provisioning system may then arrange to adjust the computing resource for the first end-user application when both the centralized recommendation and the decentralized recommendation indicate that the adjustment is appropriate.

### BACKGROUND

An enterprise may utilize applications or services executing in a cloud computing environment. For example, a business might utilize applications that execute at a data center to process purchase orders, human resources tasks, payroll functions, etc. Such applications may execute via a cloud computing environment to efficient utilize computing resources (e.g., memory, bandwidth, disk usage, etc.). When necessary, the amount of resources allocated to a particular application might be adjusted (e.g., increased or decreased) as appropriate. Note, however, that adjusting resources when not necessary (e.g., by increasing a memory allocation when such an increase is not needed), can be expensive (in terms of computing resources) and time consuming.

It would therefore be desirable to provide resource allocation for cloud-based computing environment applications in an accurate an efficient manner.

### SUMMARY

Methods and systems may be associated with a cloud computing environment, and a centralized resource provisioning system may associated with a plurality of end-user applications in the cloud-based computing environment. The centralized resource provisioning system may include a policy decision maker that generates a centralized recommendation for a computing resource of a first end-user application. An application decision maker may be associated with the first end-user application and generate a decentralized recommendation for the computing resource of the first end-user application. A machine controller of the centralized resource provisioning system may then arrange to adjust the computing resource for the first end-user application when both the centralized recommendation and the decentralized recommendation indicate that the adjustment is appropriate.

Some embodiments comprise: means for generating, by a policy decision maker of a centralized resource provisioning system associated with a plurality of end-user applications in a cloud-based computing environment, a centralized recommendation for a computing resource of a first end-user application; means for generating, by an application decision maker associated with the first end-user application, a decentralized recommendation for the computing resource of the first end-user application; and means for arranging, by a machine controller of the centralized resource provisioning system, to adjust the computing resource for the first end-user application when both the centralized recommendation and the decentralized recommendation indicate that the adjustment is appropriate.

Other embodiments comprise: means for binding an end-user application to a centralized resource provisioning system associated with a cloud-based computing environment; means for establishing an application decision maker for the end-user application; means for monitoring, by a policy decision maker of the centralized resource provisioning system, to generate a centralized recommendation for a computing resource of the first end-user application; means for receiving, at the application decision maker, the centralized recommendation; if there is a conflict between the centralized recommendation and a decentralized recommendation generated by the application decision maker, means for arranging to adjust the computing resource for the first end-user application based on the decentralized recommendation; and, if there is not conflict between the centralized recommendation and the decentralized recommendation, means for arranging to adjust the computing resource for the first end-user application based on the centralized recommendation.

Some technical advantages of some embodiments disclosed herein are improved systems and methods to provide resource allocation for cloud-based computing environment applications in an accurate an efficient manner.

### BRIEF DESCRIPTION OF THE DRAWINGS

FIG. 1 illustrates a known resource provisioning system for a cloud-based computing environment.

FIG. 2 is a high-level system architecture in accordance with some embodiments.

FIG. 3 is a method according to some embodiments.

FIG. 4 is a more detailed system architecture in accordance with some embodiments.

FIGS. 5 through 7 are resource provisioning examples according to some embodiments.

FIG. 8 is a human machine interface display in accordance with some embodiments.

FIG. 9 is an apparatus or platform according to some embodiments.

FIG. 10 illustrates a application decision maker database in accordance with some embodiments.

FIG. 11 is a more detailed method according to some embodiments.

FIG. 12 illustrates a tablet computer in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

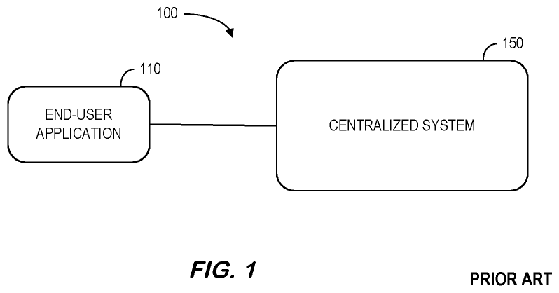

Note that the efficient allocation of computing resources may be very important in cloud applications. For example, FIG. 1 illustrates a prior art system 100 where a centralized system 100 may allocate resources to an end-user application 110. Although a single end-user application 150 is illustrated in FIG. 1, note that a single centralized system 150 may allocate resources for multiple end-user applications 110. Moreover, there are several approaches to allocating and deallocating resources in a cloud-based environment. For example, the centralized system 150 might use reactive autoscaling where a rule-based or schedule-based approach is specified by consumer. For example, rules might be defined for processor usage, memory consumption, response times, etc. Consider, for example, a consumer that specifies a processor higher threshold of 60% and lower threshold of 30%. If an autoscaling centralized system 150 determines that processor usage is currently more than 60%, resources for the end-user application 110 will be increased. If the autoscaling centralized system 150 predicts that processor usage will soon be less than 30%, the resources allocated to the end-user application 110 will be reduced. Such an approach is not deterministic and reacts only after certain criteria is met (and, as a result, the reaction might be performed too late). Moreover, reactive autoscaling is usually only supported with respect to a single metric (and is independent of other metrics).

A predictive autoscaling centralized system 150, in contrast, might instead look at past system 100 behavior and attempt to predict future computing resource needs for the end-user application 110. Such an approach is deterministic in approach and can scale up or down accordingly. However, predictive scaling takes a longer amount of time to tune the model and the quality of the past data set is important for accurate predictions. Although predictive autoscaling can utilize multiple variable to make predictions, it still makes use of a centralized system 150 to ultimately make the resource allocation decision.

Some of the challenges faced by systems that use reactive and/or predictive autoscaling include:
Decisions are made by a centralized component. For every application, the same approach is used irrespective of different data usage, network usage, memory usage, and/or other parameters that might play an important role and act as differentiator.
The end-user application does not have control over the autoscaling decision. There is one generic rule for all different applications.
No mechanism is provided to let applications define their own specific scenarios where an autoscaling rule or policy should not be applied.

To help avoid these drawbacks, some embodiments described herein may de-centralize the autoscaling component and allow for input from the end-user application before a resource allocation is made. Such an approach may have the following benefits:
It may allow an application to define specific rules to scale-up or scale-down. These rules can be very application specific, and only the application itself needs to be aware of rules.
It may let end-users define rules about when to avoid or ignore certain application behavior (e.g., perhaps no false scale-ups or scale-downs should occur as a result of an application update).

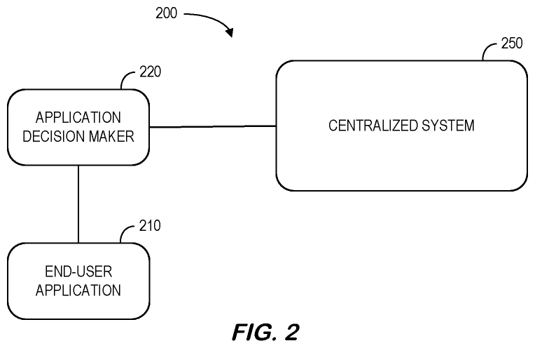

FIG. 2 is a high-level system 200 architecture in accordance with some embodiments. The system 200 includes an end-user application 210, an application decision maker 220, and a centralized system 250. As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The centralized system 250 may store information into and/or retrieve information from various data stores, which may be locally stored or reside remote from the centralized system 250. Although a single centralized system 250, end-user application 210, and application decision maker 220 are shown in FIG. 2, any number of such devices may be included. Moreover, various devices described herein might be combined according to embodiments of the present invention. For example, in some embodiments, end-user application 210 and application decision maker 220 might comprise a single apparatus. The system 200 functions may be performed by a constellation of networked apparatuses, such as in a distributed processing or cloud-based architecture.

According to some embodiments, an operator or administrator may access the system 200 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to implement various rules and policies) and/or provide or receive automatically generated recommendations or results from the system 200.

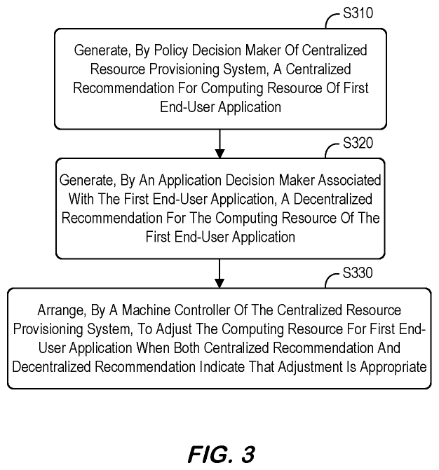

FIG. 3 is a method that might be performed by some or all of the elements of any embodiment described herein. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S310, a policy decision maker of a centralized resource provisioning system associated with a plurality of end-user applications in the cloud-based computing environment may generate a centralized recommendation for a “computing resource” of a first end-user application. As used herein, the phrase “computing resource” might refer to, for example, a memory allocation, a Central Processing Unit (“CPU”) allocation, a network bandwidth allocation, a disk allocation, etc. Moreover, the term “application” might refer to, by ways of example only, an Infrastructure-as-a-Service (“IaaS”) or a Platform-as-a-Service (“PaaS”). Note that the centralized recommendation might be based on application logs associated with the first end-user application and could be based on reactive autoscaling, predictive autoscaling, or any other resource provisioning rules or logic.

At S320, an application decision maker associated with the first end-user application may generate a decentralized recommendation for the computing resource of the first end-user application. The decentralized recommendation might be based on reactive autoscaling, predictive autoscaling, or any other resource provisioning rules or logic. At S330, a machine controller of the centralized resource provisioning system may arrange to adjust the computing resource for the first end-user application when both the centralized recommendation and the decentralized recommendation indicate that the adjustment is appropriate. According to some embodiments, the centralized resource provisioning system may also arrange to adjust the computing resource for the first end-user application when the centralized recommendation indicates that the adjustment is appropriate and there is communication failure between the centralized resource provisioning system and the application decision maker.

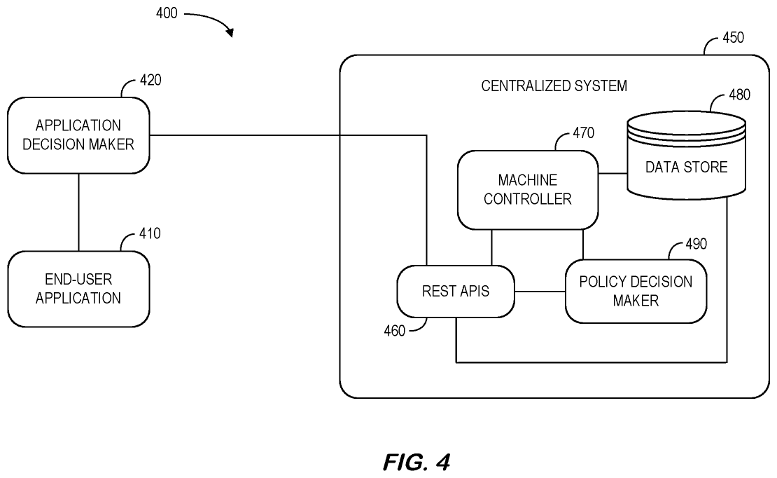

FIG. 4 is a more detailed system 400 architecture in accordance with some embodiments. As before, the system 400 includes an end-user application 410, an application decision maker 420, and a centralized system 450. The application decision maker 420 may communicate with the centralized resource provisioning system 450 via a Representational State Transfer (“REST”) Application Programming Interface (“API”) 460. A policy decision maker 490 may contain centralized resource allocation logic, and a machine controller 470 may access a data store 480 to evaluate prior log files and/or facilitate cloud controller decisions. In this embodiment, the application decision maker 420 acts as broker between the end-user application 410 and the centralized system 450 with respect to resource allocation decision making decision making

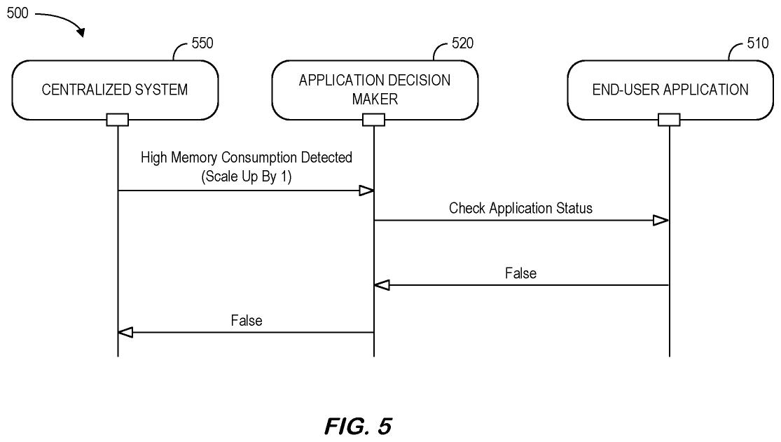

For example, FIGS. 5 through 7 are resource provisioning examples according to some embodiments. In some cases, a centralized system may detect that aa scale-up might be appropriate due to high memory consumption. Consider the data flow example 500 of FIG. 5 that includes a centralized system 550, an application decision maker 520, and an end-user application 510. The centralized system 550 initially detects high memory consumption and recommends to the application decision maker 520 that memory resources be scaled up (e.g., by adding “one unit” of memory resources). The application decision maker 520 checks the status of the end-user application 510 to determine if the increase in memory resources is actually needed (e.g., instead of being a response to a temporary condition such as an application update). If the end-user application 510 indicates that scaled up memory resources are not required (“false”), the application decision maker 520 informs the centralized system 550 and, as a result, no change to the memory resource application is made. In this way, unnecessary resource upgrades (and associated time and hardware costs) associated with false alarms may be avoided.

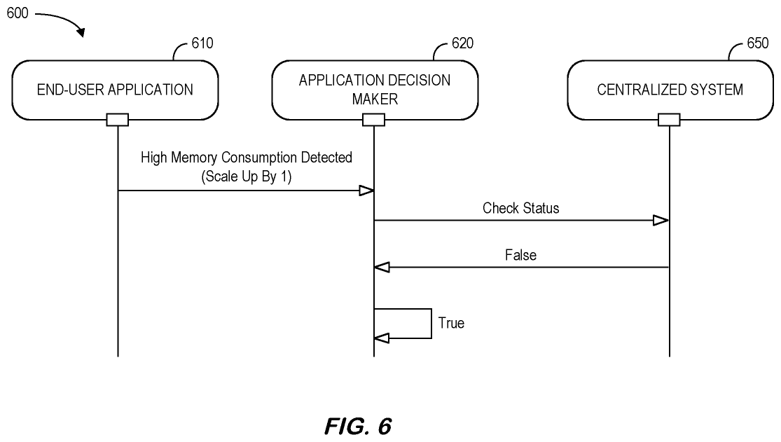

In other cases, the application itself might detect that a scale-up is needed due to high memory consumption. Consider the data flow example 600 of FIG. 6 that again includes a centralized system 650, an application decision maker 620, and an end-user application 610. Here, the end-user application 610 initially detects (e.g., using either reactive or predictive techniques) high memory consumption and recommends to the application decision maker 620 that memory resources be scaled up (e.g., by adding “one unit” of memory resources). The application decision maker 620 checks with the centralized system 650 to determine if the increase in memory resources is possible. If the end-user application 610 indicates that scaled up memory resources are not possible (“false”), the application decision maker 620 takes no further action.

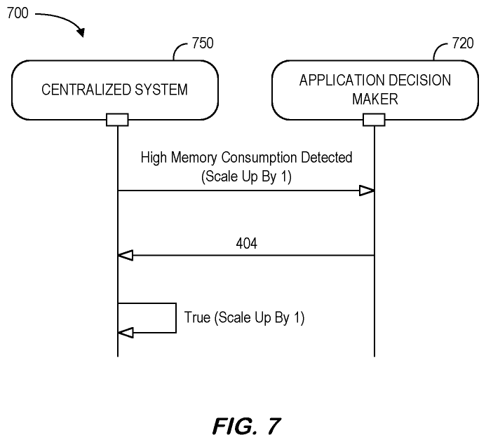

Now consider the situation where a centralized system is unable to communicate with an application decision maker. Consider the data flow example 700 of FIG. 7 that includes a centralized system 750 and an application decision maker 720. Again, the centralized system 750 initially detects high memory consumption and recommends to the application decision maker 720 that memory resources be scaled up (e.g., by adding “one unit” of memory resources). Although a 404 error is illustrated in FIG. 7 as an example, note that embodiments might be associated with any other type of communication error (e.g., a database timeout, a rate limit has been reached, the application decision 720 maker is currently being upgraded, etc.). In this case, the application decision maker 720 returns a 404 error” HTTP status code indicating that it cannot currently be reached (e.g., the system may be temporarily down). Since the application decision maker 720 is not available, the centralized system 750 goes ahead and arranges for the memory resources of the end-user application to be increased (e.g., as a “best guess” under the circumstances).

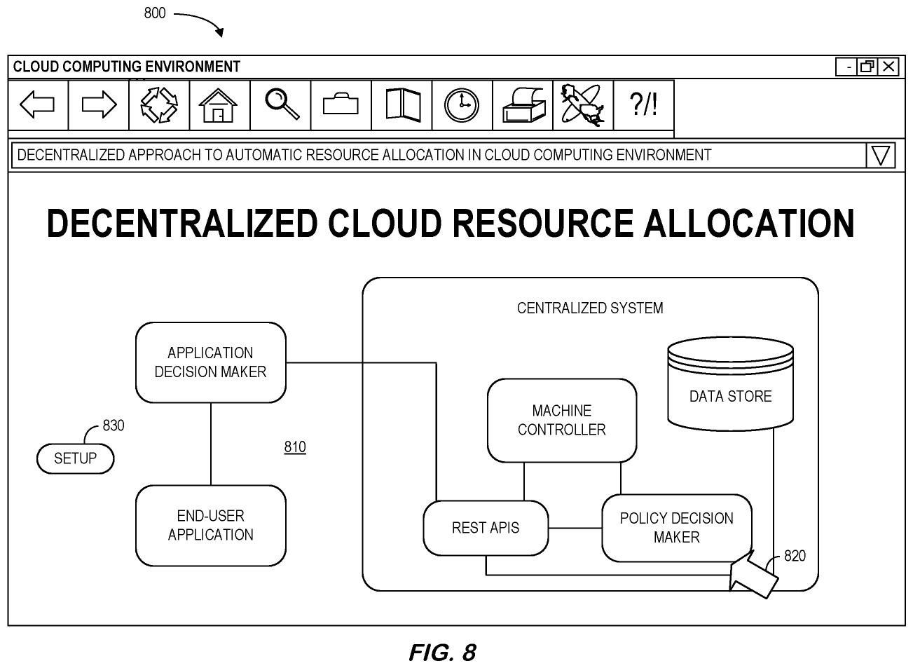

FIG. 8 is a human machine interface display 800 in accordance with some embodiments. The display 800 includes a graphical representation 810 of elements of cloud-based computing environment (e.g., associated with a decentralized cloud resource allocation). Selection of an element (e.g., via a touch-screen or computer pointer 1120) may result in display of a pop-up window containing various options (e.g., to adjust rules or logic, assign various devices, change an allocation policy, etc.). The display 800 may also include a user-selectable “Setup” icon 830 (e.g., to configure parameters for cloud management/provisioning as described with respect any of the embodiments of FIGS. 2 through 7).

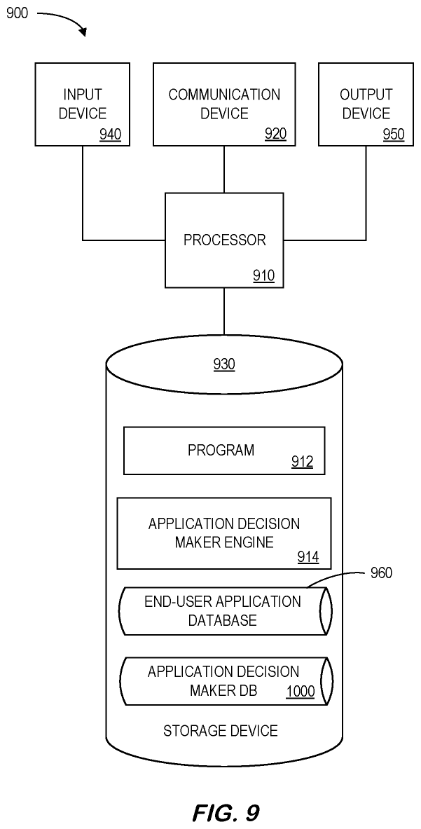

Note that the embodiments described herein may be implemented using any number of different hardware configurations. For example, FIG. 9 is a block diagram of an apparatus or platform 900 that may be, for example, associated with the systems 200, 400 of FIGS. 2 and 4, respectively (and/or any other system described herein). The platform 900 comprises a processor 910, such as one or more commercially available CPUs in the form of one-chip microprocessors, coupled to a communication device 920 configured to communicate via a communication network (not shown in FIG. 9). The communication device 920 may be used to communicate, for example, with one or more remote user platforms, cloud resource providers, etc. The platform 900 further includes an input device 940 (e.g., a computer mouse and/or keyboard to input rules or logic) and/an output device 950 (e.g., a computer monitor to render a display, transmit recommendations, and/or create data center reports). According to some embodiments, a mobile device and/or PC may be used to exchange information with the platform 900.

The processor 910 also communicates with a storage device 930. The storage device 930 can be implemented as a single database or the different components of the storage device 930 can be distributed using multiple databases (that is, different deployment information storage options are possible). The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or an application decision maker engine 914 for controlling the processor 910. The processor 910 performs instructions of the programs 912, 914, and thereby operates in accordance with any of the embodiments described herein. For example, the processor 910 might implement a policy decision maker that generates a centralized recommendation for a computing resource of a first end-user application. The processor 910 might instead implement an application decision maker that is associated with the first end-user application and generate a decentralized recommendation for the computing resource of the first end-user application. According to some embodiments, the processor 910 will arrange to adjust the computing resource for the first end-user application when both the centralized recommendation and the decentralized recommendation indicate that the adjustment is appropriate.

The programs 912, 914 may be stored in a compressed, uncompiled and/or encrypted format. The programs 912, 914 may furthermore include other program elements, such as an operating system, clipboard application, a database management system, and/or device drivers used by the processor 910 to interface with peripheral devices.

As used herein, information may be “received” by or “transmitted” to, for example: (i) the platform 900 from another device; or (ii) a software application or module within the platform 900 from another software application, module, or any other source.

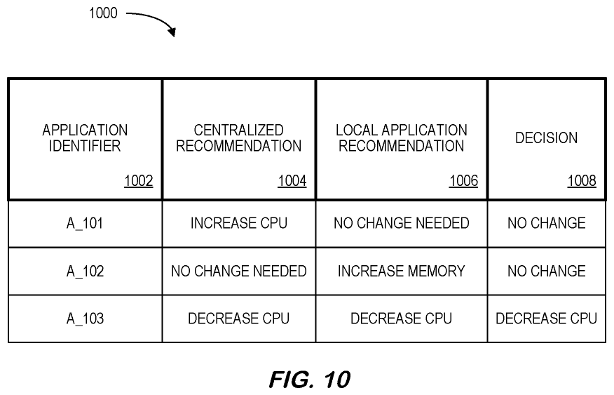

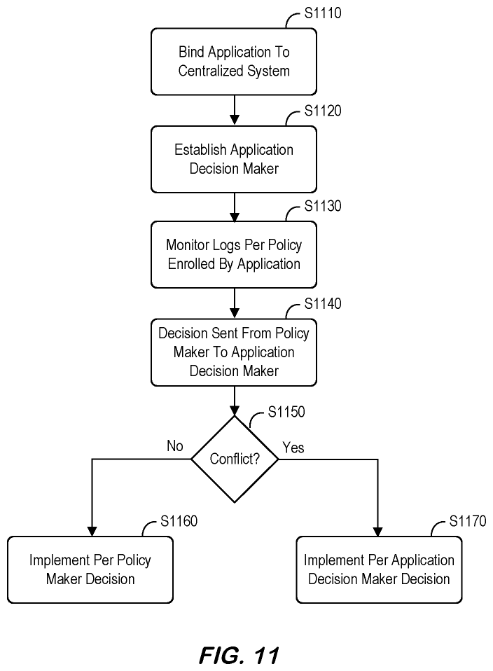

In some embodiments (such as the one shown in FIG. 9), the storage device 930 further stores an application database 960 and an application decision maker database 1000. An example of a database that may be used in connection with the platform 900 will now be described in detail with respect to FIG. 10. Note that the database described herein is only one example, and additional and/or different information may be stored therein. Moreover, various databases might be split or combined in accordance with any of the embodiments described herein.

Referring to FIG. 10, a table is shown that represents the application decision maker database 1000 that may be stored at the platform 1000 according to some embodiments. The table may include, for example, entries identifying applications potential resource adjustments for those applications. The table may also define fields 1002, 1004, 1006, 1008, for each of the entries. The fields 1002, 1004, 1006, 1008 may, according to some embodiments, specify: an application identifier 1002, a centralized recommendation 1004, local application (“decentralized”) recommendation 1006, and decision 1008. The application decision maker database 1000 may be created and updated, for example, when a new application is executed, a reactive or proactive change in resource requirements is determined, etc.

The application identifier 1002 might be a unique alphanumeric label or link that is associated with an end-user application that is executing in a cloud-based computing environment. The centralized recommendation 1004 might be result of a policy decision that uses reactive or proactive techniques to detect a potential change in computing resource requirements (e.g., a CPU allocation, a disk allocation, etc.) and could indicate, for exchange, that a change is needed (e.g., an increase or decrease) or that a change is not needed. The local application recommendation 1006 might be result of an application decision maker that uses reactive or proactive techniques to detect a potential change in computing resource requirements and could indicate, for exchange, that a change is needed or that a change is not needed. The decision 1008 may represent the final action that the system has determined to take with respect to the change in resource allocation. For example, the decision 1008 indicate that the change will be made (e.g., when both the centralized recommendation 1004 and local application recommendation 1006 indicate that the change is appropriate) or that no change was made.

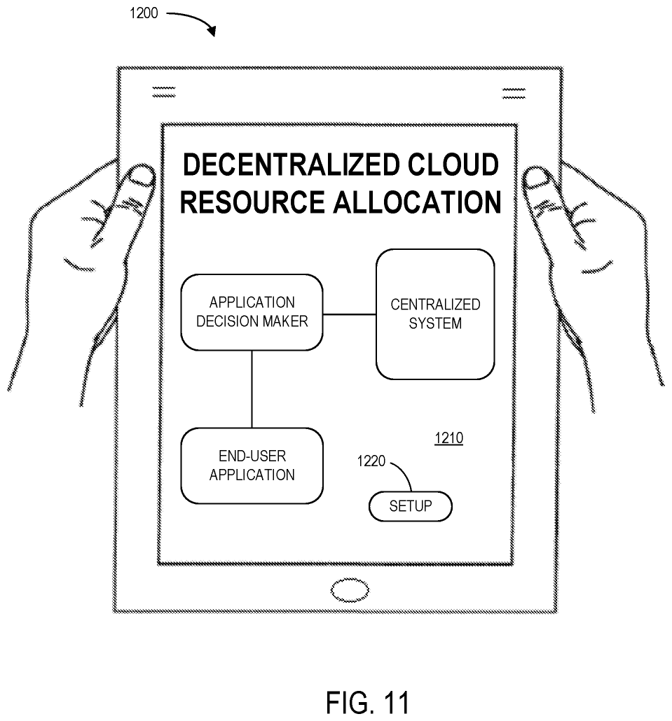

FIG. 11 is method associated with a proposed algorithm in accordance with some embodiments. At S1110, an application may bins to a centralized system as per policy plans. For example, an end-user application may bind to a centralized resource provisioning system associated with a cloud-based computing environment. At S1120, the application will have an application decision maker component where it can specify specific cases and expected behavior that are not covered in policy plans. For example, an application decision maker might be established for the end-user application such that no scale-up or scale-down should occur during scheduled updates.

At S1130, an autoscaling policy decision maker may monitor all logs of the application, as per the policy enrolled by the application, make a decision, and send that decision to the application. For example, a policy decision maker of the centralized resource provisioning system may monitor logs to generate a centralized recommendation for a computing resource of the first end-user application. Note that the application decision maker may function as a communicator between the application and the policy decision maker. At S1140, the application decision maker receives the decision from the policy maker.

The application decision maker may behave as per autoscaling policy maker's decision. If there is a conflict between decision by central system and the application, embodiments may give priority to the application decision. That is, if there is a conflict between the centralized recommendation and a decentralized recommendation generated by the application decision maker at S1150, the system may arrange to adjust the computing resource for the first end-user application based on the decentralized recommendation at S1170. If there is not conflict between the centralized recommendation and the decentralized recommendation at S1150, the system arrange to adjust the computing resource for the first end-user application based on the centralized recommendation at S1160. In cases where application decision maker is unable to connect to centralized system (or vice versa), after a timeout period a decision might be made in accordance with either the centralized system or the application. According to some embodiments, the proposed algorithm of FIG. 11 will monitor multiple types of computing recourses (such as memory, CPU, disk, etc.) for a bounded application.

Thus, embodiments may provide resource allocation for cloud-based computing environment applications in an accurate an efficient manner. This may help reduce false scale-ups and/or scale-downs of resources and saving cloud resources (thus more effectively using the resources available to the application). Such an approach may save the extra costs than can be caused by the unnecessary use of autoscaling.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

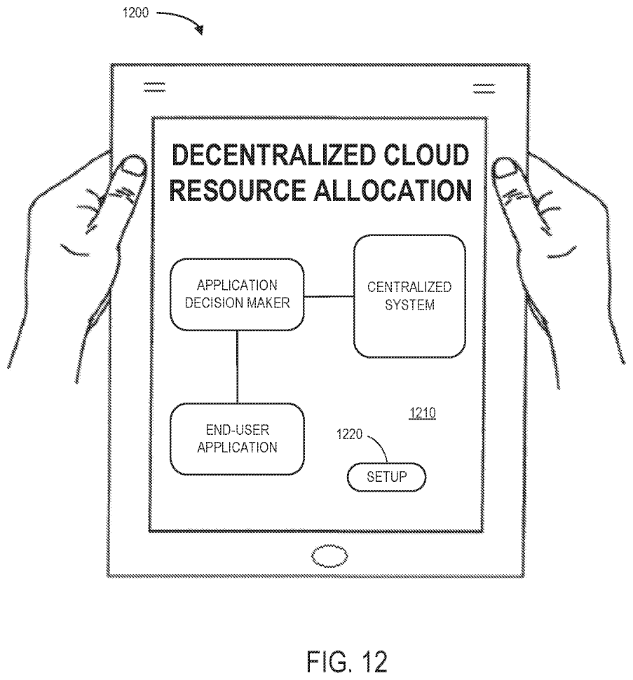

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented. For example, FIG. 12 shows a tablet computer 1200 rendering a decentralized cloud resource allocation display 1210. The display 1210 may, according to some embodiments, be used to view more detailed elements about components of the system (e.g., when a graphical element is selected via a touchscreen) and/or to configure operation of the system (e.g., to establish new rules or logic for the system via a “Setup” icon 1220).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with a cloud-based computing environment, comprising:
a centralized resource provisioning system, associated with a plurality of end-user applications in the cloud-based computing environment, including:
a policy decision maker to generate a centralized recommendation for a computing resource of a first end-user application based, at least in part, on application-specific rules specific to the first end-user application; and
an application decision maker, associated with the first end-user application, to generate a decentralized recommendation for the computing resource of the first end-user application,
wherein a machine controller of the centralized resource provisioning system arranges to adjust the computing resource for the first end-user application when both the centralized recommendation and the decentralized recommendation indicate that the adjustment is appropriate.

2. The system of claim 1, wherein the computing resource is associated with at least one of: (i) a memory allocation, (ii) a central processing unit allocation, (iii) a network bandwidth allocation, and (iv) a disk allocation.

3. The system of claim 1, wherein the centralized recommendation is based on application logs associated with the first end-user application.

4. The system of claim 1, wherein the centralized recommendation is based on at least one of: (i) reactive autoscaling, and (ii) predictive autoscaling.

5. The system of claim 1, wherein the decentralized recommendation is based on at least one of: (i) reactive autoscaling, and (ii) predictive autoscaling.

6. The system of claim 1, wherein the application decision maker communicates with the centralized resource provisioning system via a representational state transfer application programming interface.

7. The system of claim 6, wherein the centralized resource provisioning system arranges to adjust the computing resource for the first end-user application when the centralized recommendation indicates that the adjustment is appropriate and there is communication failure between the centralized resource provisioning system and the application decision maker.

8. The system of claim 1, wherein the end-user application is associated with at least one of: (i) an Infrastructure-as-a-Service (“IaaS”), and (ii) a Platform-as-a-Service (“PaaS”).

9. A computer-implemented method associated with a cloud-based computing environment, comprising:
generating, by a policy decision maker of a centralized resource provisioning system associated with a plurality of end-user applications in the cloud-based computing environment, a centralized recommendation for a computing resource of a first end-user application based, at least in part, on application-specific rules specific to the first end-user application;
generating, by an application decision maker associated with the first end-user application, a decentralized recommendation for the computing resource of the first end-user application; and
arranging, by a machine controller of the centralized resource provisioning system, to adjust the computing resource for the first end-user application when both the centralized recommendation and the decentralized recommendation indicate that the adjustment is appropriate.

10. The method of claim 9, wherein the computing resource is associated with at least one of: (i) a memory allocation, (ii) a central processing unit allocation, (iii) a network bandwidth allocation, and (iv) a disk allocation.

11. The method of claim 9, wherein the centralized recommendation is based on application logs associated with the first end-user application.

12. The method of claim 9, wherein the centralized recommendation is based on at least one of: (i) reactive autoscaling, and (ii) predictive autoscaling.

13. The method of claim 9, wherein the decentralized recommendation is based on at least one of: (i) reactive autoscaling, and (ii) predictive autoscaling.

14. The method of claim 9, wherein the application decision maker communicates with the centralized resource provisioning system via a representational state transfer application programming interface.

15. The method of claim 14, wherein the centralized resource provisioning system arranges to adjust the computing resource for the first end-user application when the centralized recommendation indicates that the adjustment is appropriate and there is communication failure between the centralized resource provisioning system and the application decision maker.

16. The method of claim 9, wherein the end-user application is associated with at least one of: (i) an Infrastructure-as-a-Service (“IaaS”), and (ii) a Platform-as-a-Service (“PaaS”).

17. A non-transitory, computer readable medium having executable instructions stored therein which are executable by a processor to:
bind an end-user application to a centralized resource provisioning system associated with a cloud-based computing environment;
establish an application decision maker for the end-user application;
monitor, by a policy decision maker of the centralized resource provisioning system, end-user application logs to generate a centralized recommendation for a computing resource of the first end-user application based, at least in part, on application-specific rules specific to the first end-user application;
receive, at the application decision maker, the centralized recommendation;
if there is a conflict between the centralized recommendation and a decentralized recommendation generated by the application decision maker, arrange to adjust the computing resource for the first end-user application based on the decentralized recommendation; and
instructions to, if there is not conflict between the centralized recommendation and the decentralized recommendation, arrange to adjust the computing resource for the first end-user application based on the centralized recommendation.

18. The medium of claim 17, wherein the computing resource is associated with at least one of: (i) a memory allocation, (ii) a central processing unit allocation, (iii) a network bandwidth allocation, and (iv) a disk allocation.

19. The medium of claim 17, wherein the centralized recommendation is based on application logs associated with the first end-user application.

20. The medium of claim 17, wherein the centralized recommendation is based on at least one of: (i) reactive autoscaling, and (ii) predictive autoscaling.
